(19) United States
(12) Patent Application Publication
(10) Pub. No.: US 2002/0072903 A1
(43) Pub. Date: Jun. 13, 2002

(54) Rate control device for variable-rate voice encoding system and method thereof

(76) Inventors: Hideaki Kurihara, Kawasaki (JP); Masato Ito, Kawasaki (JP); Rika Nishiike, Kawasaki (JP)

Correspondence Address: Rosenman & Colin LLP, 575 Madison Avenue, New York, NY, 10022-2585, US

(21) Appl. No.: 10/066,463

(22) Filed: Jan. 31, 2002

Related U.S. Application Data
(63) Continuation of application No. PCT/JP99/06051, filed on Oct. 29, 1999.

(51) Int. Cl. G10L 19/02

(52) U.S. Cl. 704/229

(57) ABSTRACT

Conventionally, the bit rate of a voiceless part of a voice signal is lowered distinguishing the voiceless part from the voice part; according to the invention, the bit rate of the voice part is also lowered. The voice part is constituted of a vowel sound and a consonant sound. The vowel sound can be reproduced with almost no degradation of the quality by reproducing both the vocal track component and the pitch component even if the encoding bit rate of the other components is lowered. Therefore, when the vowel sound of the voice part is encoded, the average bit rate when the voice part is sounded is lowered by reducing the number of the encoding bits of a fixed codebook and by lowering the bit rate to half the rate. To discriminate a vowel sound, the relation between the LPC spectrum and the LSP coefficients is used. The vowel sound has high peaks in the LPC spectrum, and the LSP coefficients are present on both sides of the peaks. Therefore, when adjacent LSP coefficients are closer to each other than a predetermined threshold, it is judged that a peak is present. Such judgment is made for some of the peaks, thereby judging whether or not the sound is a vowel.

### CROSS REFERENCE TO RELATED APPLICATION

This application is a continuation of international PCT application No. PCT/JP99/06051 filed on Oct. 29, 1999.

### BACKGROUND OF THE INVENTION

1. Field of the Invention

The present invention relates to a rate control device for a variable-rate voice encoding system and a method thereof.

2. Description of the Related Art

Conventionally, in a variable-rate voice encoding system, a voice part is distinguished from a voiceless part, and a rate is changed according to the state. For example, there is North American Mobile Communications Standards TIA/IS-127 (hereinafter called “EVRC”), which is the variable-rate voice CODEC of the TIA/IS-95 system) and the like.

FIG. 1 shows the basic configuration of the conventional EVRC.

EVRC is a kind of CELP system. EVRC collectively processes data in a specific section (hereinafter called a “frame”).EVRC comprises an auto-correlation function coefficient calculating section 10, an LPC calculating section 12, an LPC-LSP converting section 13, an LSP quantizing section 14, an LSP-LPC converting section 15, a rate determining section 11, a residual signal calculating section 16, an adaptive codebook searching section 17, a fixed codebook searching section 18 and a gain quantizing section 19.

When an input signal is inputted to the device shown in FIG. 1, the signal is first inputted to the auto-correlation coefficient calculating section 10. The auto-correlation coefficient calculating section 10 calculates the auto-correlation coefficient of the input signal. The calculated auto-correlation coefficient is inputted to the LPC calculating section 12. LPC is the abbreviation of Linear Prediction Coefficient, and is used for voice encoding. The LPC calculated by the LPC calculating section 12 is converted into an LSP (Line Spectrum Pair) parameter by the LPC-LSP converting section 13. Then, the LSP parameter calculated by the LPC-LSP converting section 13 is quantized by the LSP quantizing section 14. The quantized LSP parameter is transmitted as the vocal track component of a voice signal, which is not shown in FIG. 1. The quantized LSP parameter is also converted into an LPC by the LSP-LPC converting section. Both the LPC outputted from the LPC-LSP converting section 13 and the quantized LPC outputted from the LSP-LPC converting section 15 are inputted to all of the residual signal calculating section 16, adaptive codebook searching section 17 and fixed codebook searching section 18.

The auto-correlation coefficient outputted from the auto-correlation coefficient calculating section 10 is inputted to the rate determining section 11 and is used to judge whether the current input signal is a voice part or a voiceless part. The rate determining section is generally called “VAD” (Voice Activity Detection). The rate determining section 11 distinguishes the voice part of a voice signal from when the voiceless part, and controls to change the bit rate depending on a voice part or a voiceless part. Therefore, as shown by dotted lines in FIG. 1, a signal for controlling the bit rate is inputted from the rate determining section 11 to the LSP quantizing section 14, adaptive codebook searching section 17, fixed codebook searching section 18 and gain quantizing section 19.

The residual signal calculating section 16 generates a residual signal from the input signal by eliminating the vocal track component determined by the LPC. This residual signal is inputted to the adaptive codebook searching section 17. The adaptive codebook searching section 17 vector-quantizes using an adaptive codebook and quantizes the pitch component of the residual signal. When searching for this adaptive codebook, the adaptive codebook searching section 17 obtains an LPC before quantization and an LPC after quantization from the LPC-LSP converting section 13 and LSP-LPC converting section 15, respectively, in order to select an optimal vector for minimizing the error and performs an error minimization operation. Then, the adaptive codebook searching section 17 transmits the vector-quantized pitch component as a transmitting signal. The remaining signal component obtained by eliminating the pitch component from the residual signal is inputted to the fixed codebook searching section 18. The fixed codebook searching section 18 vector-quantizes the remaining signal obtained by eliminating both vocal track and pitch components from the input signal and transmits the signal as an output signal. At this time, the fixed codebook searching section 18 performs an error minimization operation in order to search for an optimal vector in the fixed codebook like the adaptive codebook searching section 17. Therefore, the fixed codebook searching section 18 receives LPCs before and after quantization from the LPC-LSP converting section 13 and LSP-LPC converting section 15, respectively.

The voice spectrum encoding of the input signal is terminated by the fixed codebook searching section 18. Then, the gain of the remaining voice signal is quantized by the gain quantizing section 19, and the gain information is also transmitted as a transmitting signal.

EVRC includes a full rate, which is the highest bit rate, half the rate, which is a half of the full rate and a ⅛ rate, which is ⅛ of the full rate. In the rate determining section 11, the full rate and ⅛ rate are selected for a voice part and a voiceless part, respectively. Since TIA/IS-95 is of the CDMA system and each channel signal is spread-coded/transmitted, the transmitting power of each channel must be finely controlled to suppress the interference between channels and to secure channel capacity. The transmitting power is increased/reduced in conjunction with the bit rate, specifically, it is increased and reduced when the variable-rate voice encoding bit rate of EVRC is full and when it is ⅛, respectively. The bit rate, which is determined by the rate determining section 11, is called a “voice rate”. The voice rate is approximately 40 to 50% in normal communications, although the rate varies depending on the state of an input voice signal.

Although the encoding rate of a voice part must be lowered in order to lower the average encoding rate, the head/tail of a speech is lost due to the loss of the voice part, and the voice quality is greatly degraded, which is a problem.

Since the details of voice encoding is publicly known, the details are not described here. See the following references, if necessary.

(1) Nobuhiko Kitawaki, “Communications Engineering of Sound”, Japan Acoustics Society, Corona-sha (1996).

(2) Shuzo Saito and Kazuo Nakada, “Basics of Voice Information Processing”, Ohm-sha (1981).

(3) Yasunaga Niimi, “Voice Recognition”, Kyoritsu-shuppan (1979).

(4) S. Furui, “Acoustics/Voice Engineering”, Kindai-Kagaku-sha (1992).

(5) Hisayosi Suzuki, “Digital Signal Processing of Voice”, Corona-sha (1983).

(6) S. Furui, “Digital Voice Processing”, Tokai University Shuppan (1985).

(7) Tatehiro Moriya, “Voice Encoding”, the Institute of Electronics, Information and Communication Engineers (1998).

### SUMMARY OF THE INVENTION

An object of the present invention is to provide a bit rate control device for lowering a bit rate when a voice part is sounded without the degradation of the voice quality and a method thereof.

The device of the present invention for a variable-rate voice encoding system comprises a judging section judging whether a voice signal is a vowel when a voice part is sounded and a rate setting section setting a bit rate lower than a bit rate usually used when a voice part is sounded, as a voice encoding bit rate.

The method of the present invention controls a bit rate for a variable-rate voice encoding system and comprises (a) judging whether a voice signal is a vowel when the voice part of a voice signal is sounded, and (b) setting a bit rate lower than a bit rate usually used when a voice part is sounded, as a voice encoding bit rate.

According to the present invention, it is paid attention to that in voice encoding, a reproduction characteristic does not degrade so much in the case of a vowel even if there is only a small number of encoding bits in a fixed codebook is and by lowering the encoding bit rate when the voice signal is a vowel, the average encoding bit rate can be lowered even when a voice part is sounded. Therefore, compared with the conventional case where the encoding bit rate is lowered only when a voiceless part is sounded, a bit rate needed for voice transmission can be further lowered while the quality of reproduced voice is maintained.

### BRIEF DESCRIPTION OF THE DRAWINGS

FIG. 1 shows the basic configuration of the conventional EVRC.

FIG. 2 shows the basic configuration of one preferred embodiment of the present invention.

FIG. 3 shows the relation between the LPC spectrum and LSP coefficient of vowel “a”.

FIG. 4 shows the relation between the LPC spectrum and LSP coefficient of consonant “s”.

FIG. 5 shows the configuration of one preferred embodiment of a voice rate controlling section 20.

FIG. 6 shows the configuration of another preferred embodiment of the voice rate controlling section.

FIG. 7 is a flowchart showing the basic process of the voice rate controlling section.

FIG. 8 is a flowchart showing the process of an LSP interval calculating section.

FIG. 9 is a flowchart showing the first preferred embodiment of the process of a voice rate judging section.

FIG. 10 is a flowchart showing the second preferred embodiment of the process of the voice rate judging section in the case where the template of an LSP coefficient is prepared in advance as an approximate pattern representing the peak of an LPC spectrum.

FIG. 11 is a flowchart showing the third preferred embodiment of the process of the voice rate judging section in the case where the template of an LSP coefficient is provided as an approximate pattern.

FIG. 12 is a flowchart showing the fourth preferred embodiment of the process of a voice rate judging section, the accuracy of which is improved by performing the processes shown in FIGS. 9 and 10 together.

FIG. 13 shows examples of both the threshold values and template used in the process flows shown in FIGS. 8 through 12.

FIG. 14 shows examples of both a voice waveform model and the operation of the preferred embodiment of the present invention.

FIG. 15 shows the hardware configuration in the case where the preferred embodiment of the present invention is implemented by software.

### DESCRIPTION OF THE PREFERRED EMBODIMENTS

The present invention focuses on vowels (a, i, u, e, o, etc.) in rate control in the case where a voice part is sounded. In a vowel voice signal, the same spectrum component usually lasts for over several tens of seconds. At this time, since there is almost no fixed codebook component in a frame where vowels continue, the average bit rate can be lowered by reducing the number of the encoding bits of a fixed codebook and setting the transmitting bit rate to half the rate. To do so, the continuation state of a voice spectrum must be detected by an LSP coefficient obtained by converting an LPC representing the spectrum component into a frequency component. If the voice spectra continue, selecting half the rate can lower the average bit rate.

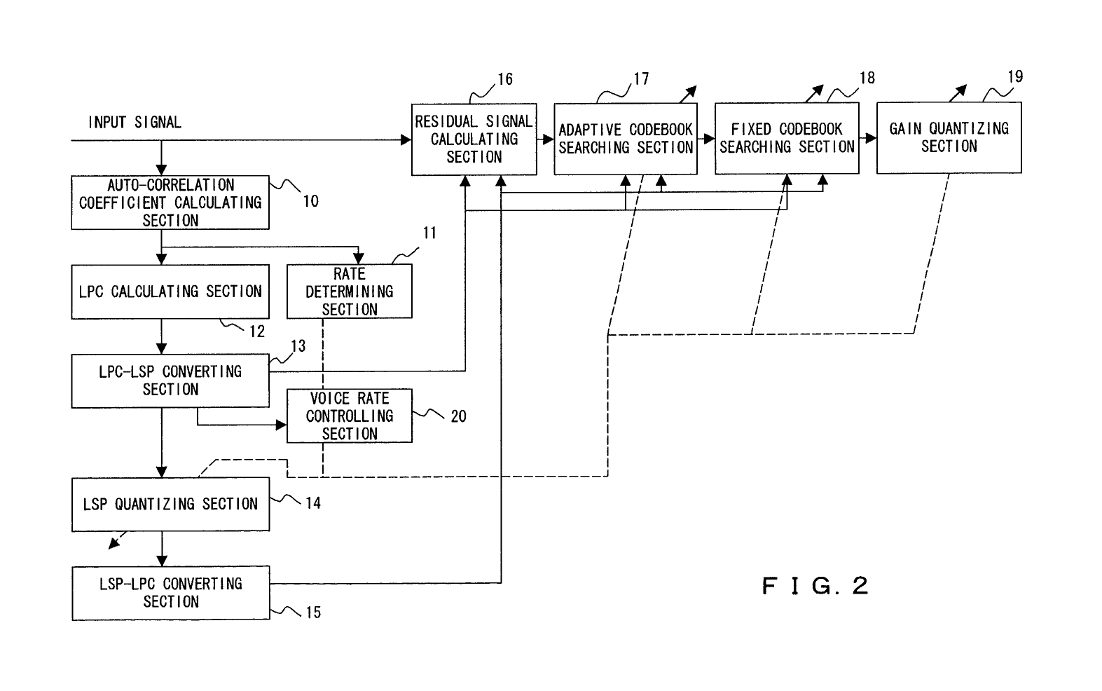

FIG. 2 shows the basic configuration of one preferred embodiment of the present invention.

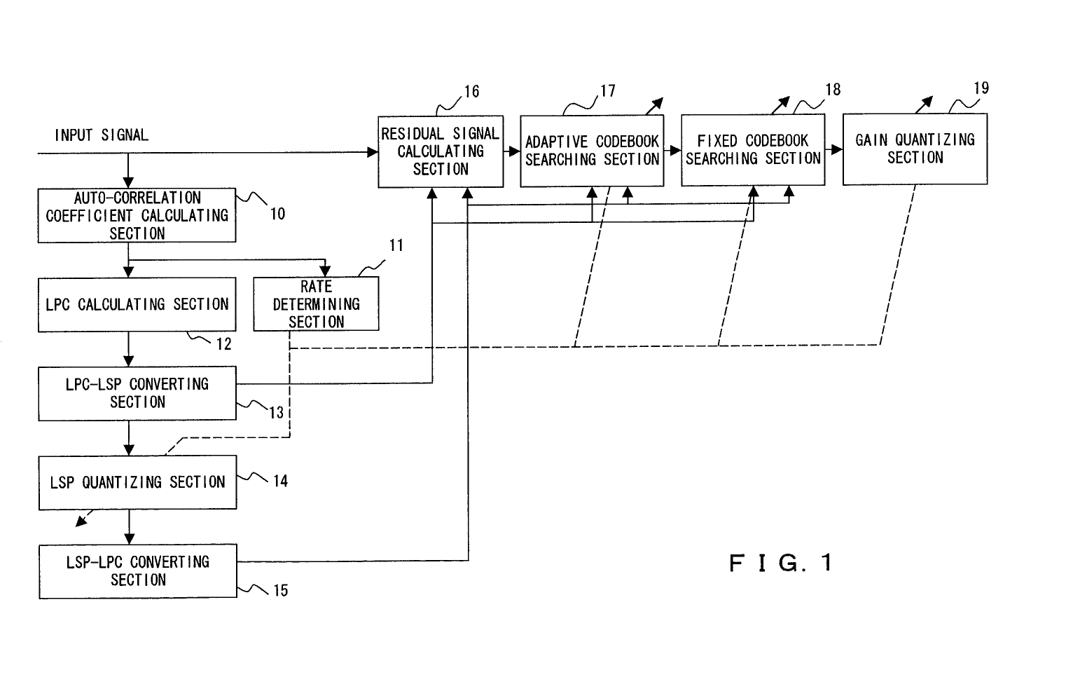

The configuration is obtained by adding a voice rate controlling section 20 to the conventional configuration shown in FIG. 1. The other constituent components are the same as those shown in FIG. 1. Specifically, an input signal, which is a voice signal, is inputted to the auto-correlation coefficient calculating section 10, and the obtained auto-correlation coefficient is inputted to both the rate determining section 11 and LPC calculating section 12. The rate determining section 11 distinguishes a voice part from a voiceless part and generates a bit rate control signal. This control signal is inputted to the voice rate controlling section 20. When a voiceless part is sounded, the voice rate controlling section 20 inputs the instruction signal from the rate determining section 11 to the LSP quantizing section 14, adaptive codebook searching section 17, fixed codebook searching section 18 and gain quantizing section 19 without performing any process on the signal. When a voice part is sounded, the voice rate controlling section 20 receives an LSP coefficient outputted from the LPC-LSP converting section 13, analyzes the LSP coefficient and judges whether the voice signal being currently processed is a vowel. If the voice signal is a vowel, the voice rate controlling section 20 reduces the number of encoding bits of the fixed codebook and sets the transmitting bit rate to half the rate. This control signal is also inputted to all of the LSP quantizing section 14, adaptive codebook searching section 17, fixed codebook searching section 18 and gain quantizing section 19.

Since the processes of the other constituent components are the same as those of the prior art, the detailed descriptions are omitted here.

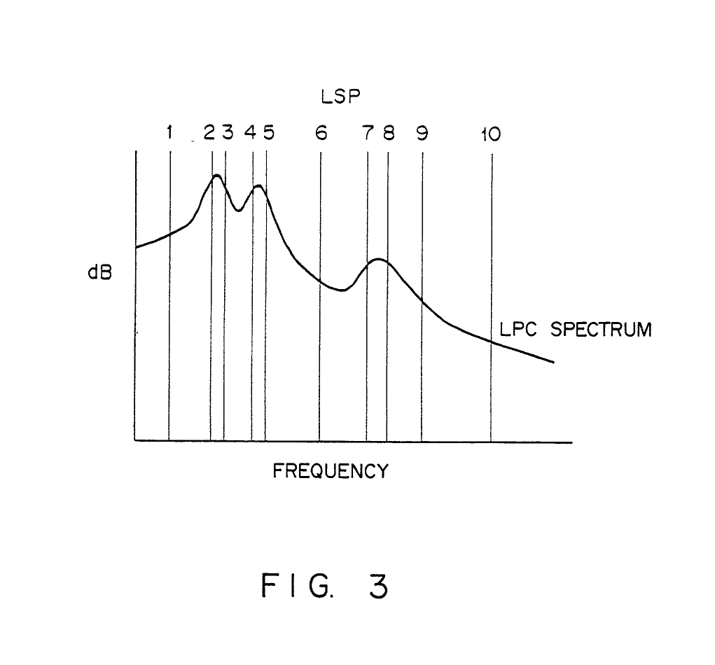

FIG. 3 shows the relation between the LPC spectrum and LSP coefficient of vowel “a”.

If the voice signal is a vowel, an LPC spectrum has several peaks on the spectrum curve, as shown in FIG. 3. This is unique to a vowel, and detecting this peak of an LPC spectrum can be used to judge whether the voice signal is a vowel or a consonant. An LSP coefficient can be used to detect this peak of an LPC spectrum. A plurality of vertical lines shown in FIG. 3 represent the positions on the frequency axis of a plurality of LSP coefficients. As is clearly seen from FIG. 3, a plurality of coefficients surrounds the peak of an LPC spectrum. It is also known that the closer the positions on the frequency axis of LSP coefficients, the higher the peak of the LPC spectrum among them. Therefore, checking the interval between the LSP coefficient values, can be used to judge whether there is a peak in an LPC spectrum.

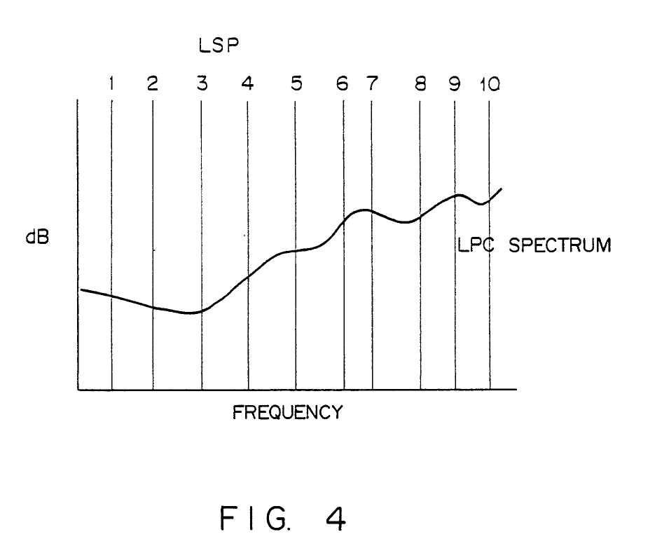

FIG. 4 shows the relation between the LPC spectrum and LSP coefficient of consonant “s”.

As shown in FIG. 4, in the case of a consonant, there is no outstanding peak in an LPC spectrum. LSP coefficients are located close to the peak of the LPC spectrum. Therefore, if there is no outstanding peak in the LPC spectrum, the LSP coefficients are located at fairly long intervals on the frequency axis. Specifically, as shown in FIG. 4, in the case of consonant “s”, LSP coefficients are almost uniformly located on the frequency axis. Therefore, no specific pair of LSP coefficients is closely located. There is a clear difference between the cases of a vowel and a consonant. Such a feature is not limited to consonant “s”, and the fact holds for all consonants. This is the general feature that distinguishes a consonant from a vowel.

Therefore, in the preferred embodiment of the present invention, a vowel is distinguished from a consonant based on whether a specific pair of LSP coefficients are more closely located on the frequency axis than a prescribed threshold value. If an inputted voice signal is judged to be a vowel, the number of encoding bits allocated to the fixed codebook is reduced and the transmitting bit rate of the signal is lowered to half the rate.

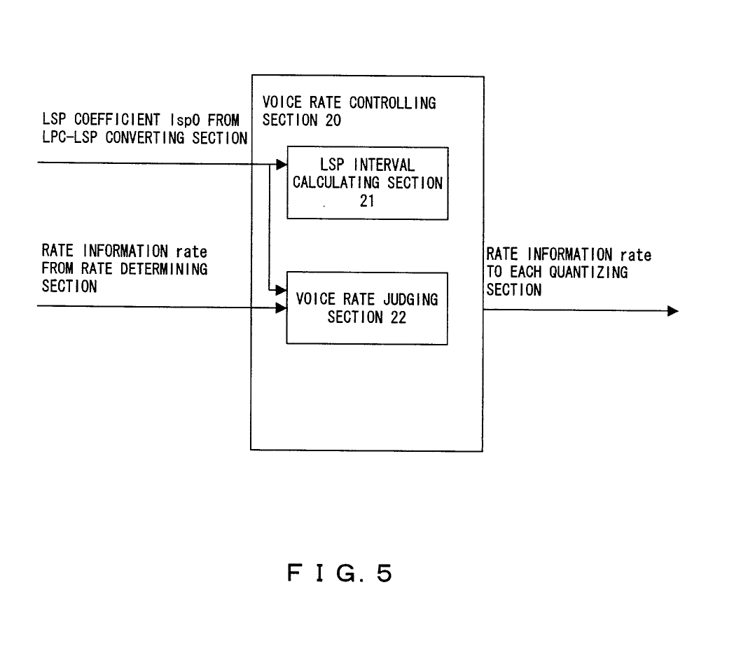

FIG. 5 shows the configuration of one preferred embodiment of the voice rate controlling section 20.

The voice rate controlling section 20 of this preferred embodiment comprises an LSP interval calculating section 21 calculating intervals on the frequency axis between two adjacent coefficients of LSP coefficients lsp ( ) inputted by the LPC-LSP converting section 13 shown in FIG. 2, and a voice rate judging section 22 judging that an inputted voice signal is a vowel, based on both the rate information “rate” from the rate determining section 11 shown in FIG. 2 and the interval information from the LSP interval calculating section, judging the continuity in the time direction of the spectrum information and modifying rate information transmitted from the rate determining section 11 from the full rate to half the rate if the rate information is the full rate.

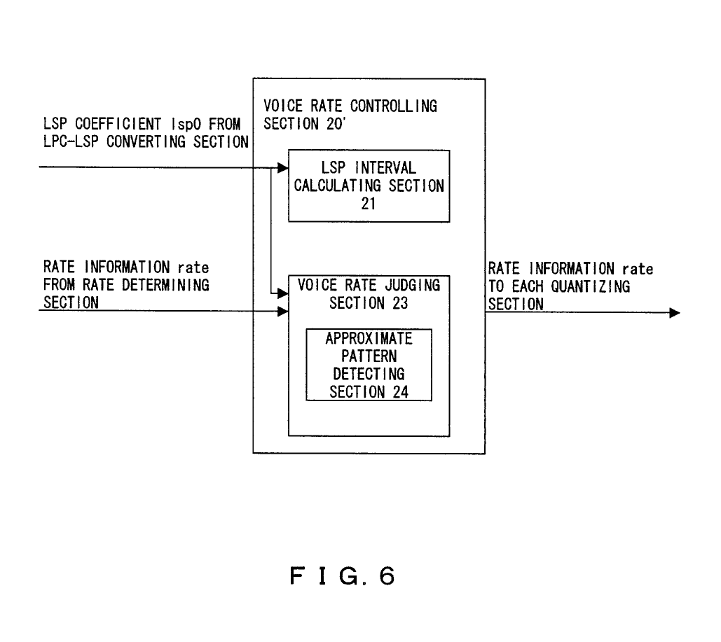

FIG. 6 shows the configuration of another preferred embodiment of the voice rate controlling section 20.

In the configuration shown in FIG. 6, a voice rate judging section 23 includes positions on the frequency axis of the LSP coefficient of a vowel as a plurality of templates in advance in an approximate pattern detecting section 24, which is provided in the voice rate judging section 23. The voice rate judging section 23 calculates an error between the transmitting bit rate and a spectrum detection signal (information indicating the position on the frequency axis of an LSP coefficient) from the LSP interval calculating section 21 and modifies/transmits the rate information “rate” if the error is kept within the threshold value.

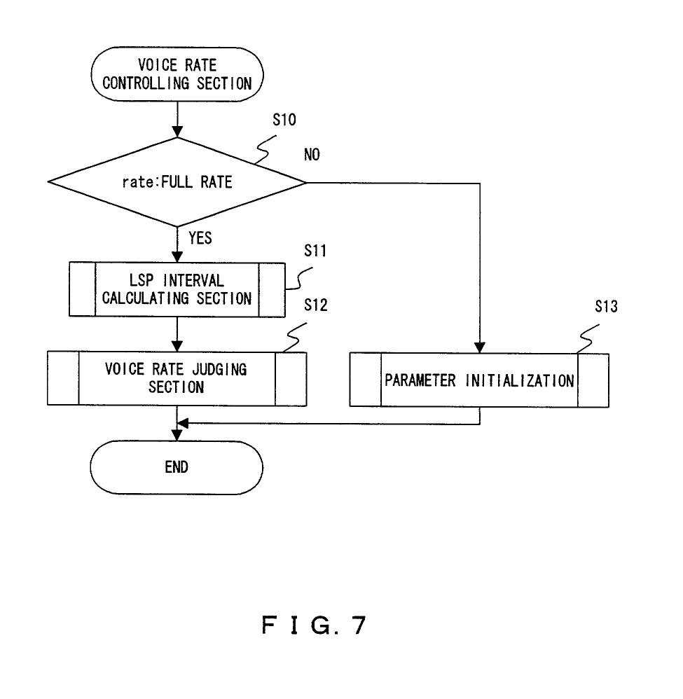

FIG. 7 is a flowchart showing the basic process of the voice rate controlling section.

First, in step S10, the voice rate controlling section judges whether the rate information “rate” indicates a full rate. If the judgment in step S10 is No, a voice signal being currently processed is voiceless. Therefore, in step S13, the parameter of the voice rate judging section is initialized and the process is terminated. If the judgment in step S10 is Yes, in step S11, the LSP interval calculating section calculates an interval and in step S12, the voice rate judging section judges the bit rate. Then, the process is terminated. The voice rate controlling section repeats these processes every time each frame is inputted.

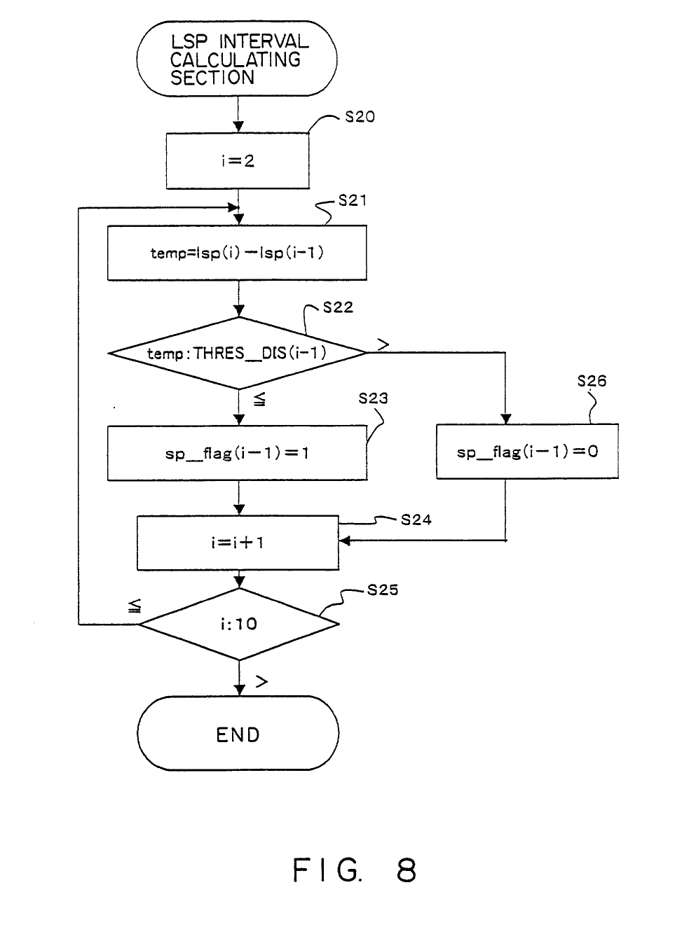

FIG. 8 is a flowchart showing the process of the LSP interval calculating section.

For example, it is assumed that the order of an LSP coefficient lsp ( ) is 10. First, in step S20, the LSP interval calculating section initializes variable i for numbering an LSP coefficient to “2”. Then, in step S21, the section calculates the difference between the i-th LSP coefficient lsp (i) and the (i-1) th LSP coefficient lsp (i-1), and stores the difference in variable temp. The value stored in temp is the interval between two adjacent LSP coefficients. The section compares this value with threshold value THRES_DIS (i-1) It is because a threshold value used to judge whether the interval between the two adjacent coefficients represents a vowel or a consonant varies depending on the frequency of a voice signal that threshold value THRES_DIS (i-1) is numbered by variable i. In this case, whether the interval represents a vowel or a consonant is judged by using different threshold values depending on the frequency or the position of an LSP coefficient. If the interval temp between two adjacent LSP coefficients is smaller than threshold value THRES_DIS (i-1), the section sets, for example, spectrum detection flag sp_flag (i-1) to “1” (step S23). Then, in step S24, the section increments i by “1” and judges whether i is larger than “10”. If i is equal to 10 or less, the flow returns to step S21, and the processes described above are repeated. If in step S22, it is judged that the interval between the two adjacent LSP coefficients is larger than threshold THRES_DIS (i-1), in step S26, the section sets spectrum detection flag sp_flag (i-1) to “0”. Then, the flow proceeds to step S24, and the section repeats the process until i becomes more than “10”. Bcause the degree of an LSP coefficient is 10 the process is repeated until i becomes “10”, as described above.

The system can also be configured so that threshold value THRES_DIS (i-1) can vary depending on the value of an LSP coefficient. In this case, it is corrected that a high-order LSP coefficient interval tends to be longer than a low-order LSP coefficient interval.

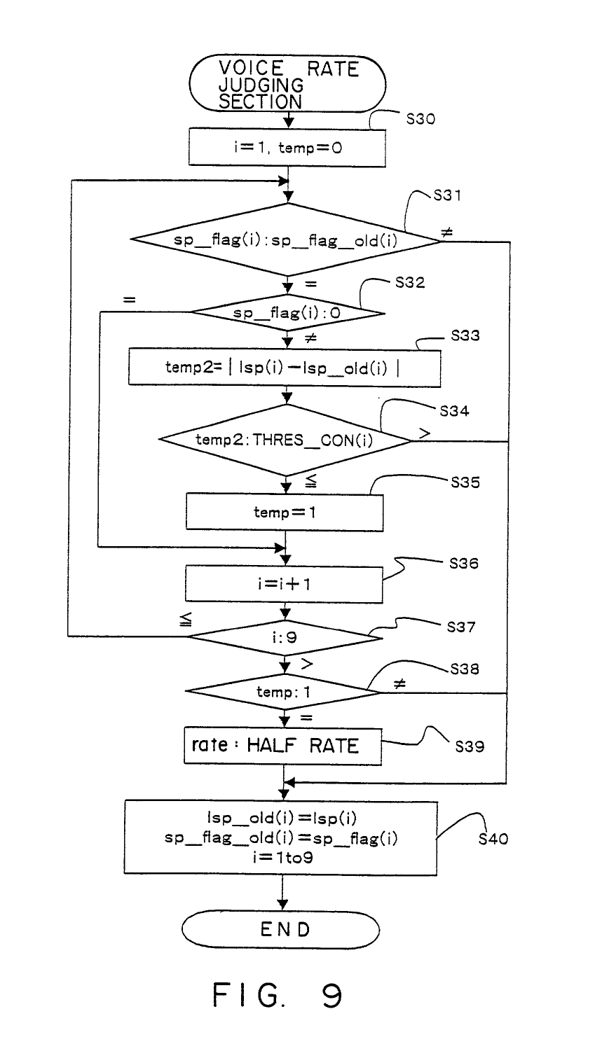

FIG. 9 is a flowchart showing the first preferred embodiment of the process of the voice rate judging section.

As described with reference to FIG. 7, if the rate information from the rate determining section does not indicate the full rate, the section initializes the data and does not modify the rate information. If the rate information indicates the full rate, first, in step S30, the section initializes both variable i indicating the number of a spectrum detection flag and variable temp indicating that a peak is detected in an LPC spectrum. Then, in step S31, the section compares the spectrum detection flag sp_flag (i) of the frame being currently processed with the spectrum detection flag sp_flag_old (i) of the immediately previous frame. If it is judged that the flags are not located in the same adjacent positions, the flow proceeds to step S40. Then, in step S40, the section sets both the current LSP coefficient and spectrum detection flag sp_flag as the immediately previous LSP coefficient and spectrum detection flag sp_flag, and terminates the process. If in step S31, it is judged that the flags of both the current LSP coefficient and spectrum detection flag sp_flag are located in the same adjacent positions as the immediately previous LSP coefficient and spectrum detection flag sp_flag, in step S32, it is checked whether the spectrum detection flag sp_flag (i) from the LSP interval calculating section is set to “0”. If the flag is set to “0”, the flow proceeds to step S36. Then, in step S36, the section increments i by one, and in step S37, the section judges whether i is equal to “9” or less. If i is equal to “9” or less, the flow returns to step S31 and the processes are repeated. If it is judged that spectrum detection flag sp_flag (i) is not set to “0”, that is, it is set to “1”, in step S33, the section calculates the absolute value temp2 of the difference between the LSP coefficient lsp_old (i) detected in the immediately previous frame and the current LSP coefficient lsp (i) of the frame being currently processed. If in step S34, temp2 is equal to threshold value THRES_CON (i) or less, the section sets variable temp to “1” (step S35), and the flow sequentially proceeds to steps S36 and S37. If in step S34, it is judged that temp2 is more than threshold value THRES_CON (i), it indicates that the value of a corresponding LSP coefficient has greatly changed and it is judged that the inputted voice signal has changed from the voice signal of the immediately previous frame. Then, the process in step S40 is performed and the entire process is terminated.

If in step S37, it is judged that i has become more than 9, in step S38, it is judged whether variable temp is set to “1”. If variable temp is not set to “1”, the process in step S40 is performed and the entire process is terminated. If in step S38, it is judged that variable temp is set to “1”, it indicates that the voice signal of the frame being currently processed is a vowel. Therefore, in step S39, the section sets the rate information to half the rate, and in step S40, the section resets the current LSP coefficient and spectrum detection flag to the immediately previous LSP coefficient and spectrum detection flag, respectively. Then, the process is terminated.

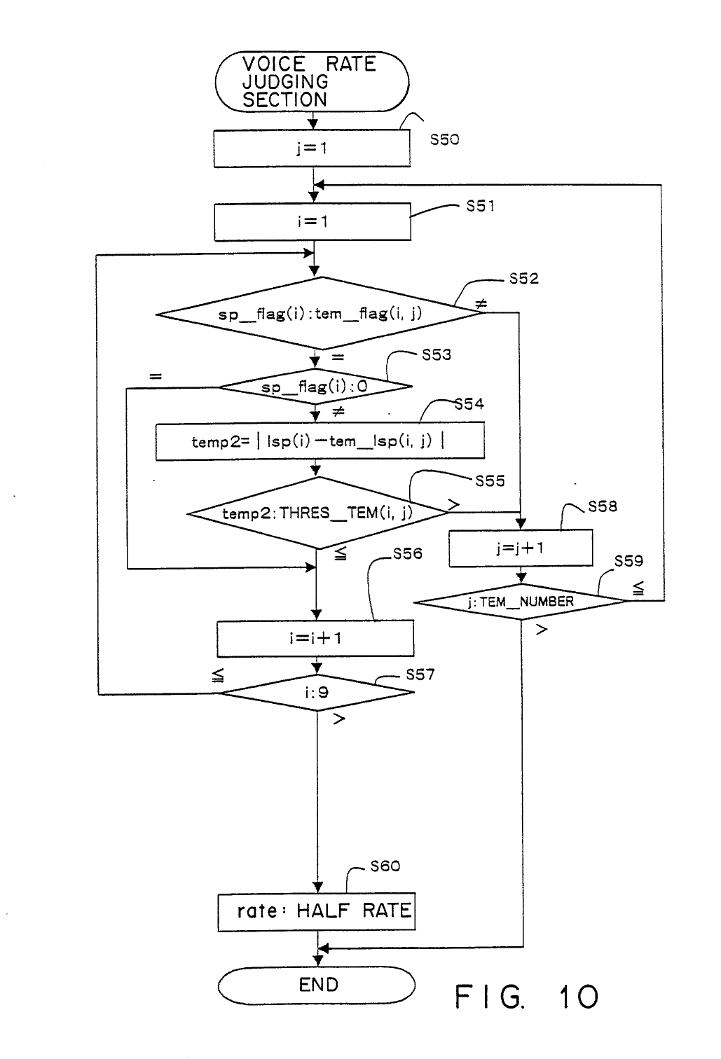

FIG. 10 is a flowchart showing the second preferred embodiment of the process of the voice rate judging section in the case where a template of an LSP coefficient is prepared in advance as an approximate pattern representing the peak of an LPC spectrum.

First, in step S50, the section sets variable j representing a number for identifying the template to “1”. Then, in step S51, the section sets the variable i of a number indicating the position of a spectrum detection flag for indicating the existence/non existence of a peak in two adjacent LSP coefficients in one template to “1”. Then, in step S52, the section compares the i-th spectrum detection flag obtained from the voice signal of a frame being currently processed with the i-th spectrum detection flag of the j-th template. If the flags are not matched, the flow proceeds to step S58. In step S58, the section increments j by one, and in step S59, the section judges whether j is equal to the prescribed number of templates TEM_NUMBER or less. If j is larger than TEM_NUMBER, it indicates that the search of all the templates is completed. Therefore, the process is terminated.

If the judgment in step S52 is Yes, in step S53, the section judges whether spectrum detection flag sp_flag (i) is set to “0”. If it is set to “0”, the flow proceeds to step S56. Instep S56, the section increments i by one, and in step S57, the section judges whether i is equal to “9” or less. If i is more than “9”, the flow proceeds to step S60. If i is equal to “9” or less, the flow proceeds to step S52 since there is still an unchecked spectrum detection flag. If in step S53, spectrum detection flag sp_flag (i) is set to “1”, the peak of an LPC spectrum is located in the position specified by i. Therefore, in steps S54, the section calculates the absolute value temp2 of the difference between the i-th LSP coefficient lsp (i) and the i-th LSP coefficient tem_lsp (i, j) of the j-th template. Then, in step S55, the section judges whether temp2 is equal to threshold value THRES_TEM (i, j) or less. The peak of the i-th LPC spectrum of the j-th template is provided with a threshold value. If temp2 is larger than threshold value THREC_TER (i, j), the flow proceeds to step S58. In step S58, the section increments j by one, and in step S59, it is judged whether all the templates are processed. If all the templates are not processed, the processes in step S51 and after are applied to a new template. If all the templates are processed, the section judges that there was no matching with the template, and terminates the process. If in step S55, it is judged that temp2 is equal to threshold value THRES_TEM (i, j) or less, the flow proceeds to step S56. In step S56, the section increments i by one, and in step S57, the section judges whether all “i”s are processed. If it is judged that all “i”s are processed, the section judges that there is matching with the template. Then, in step S60, the section sets the rate information “rate” to half the rate and terminates the process.

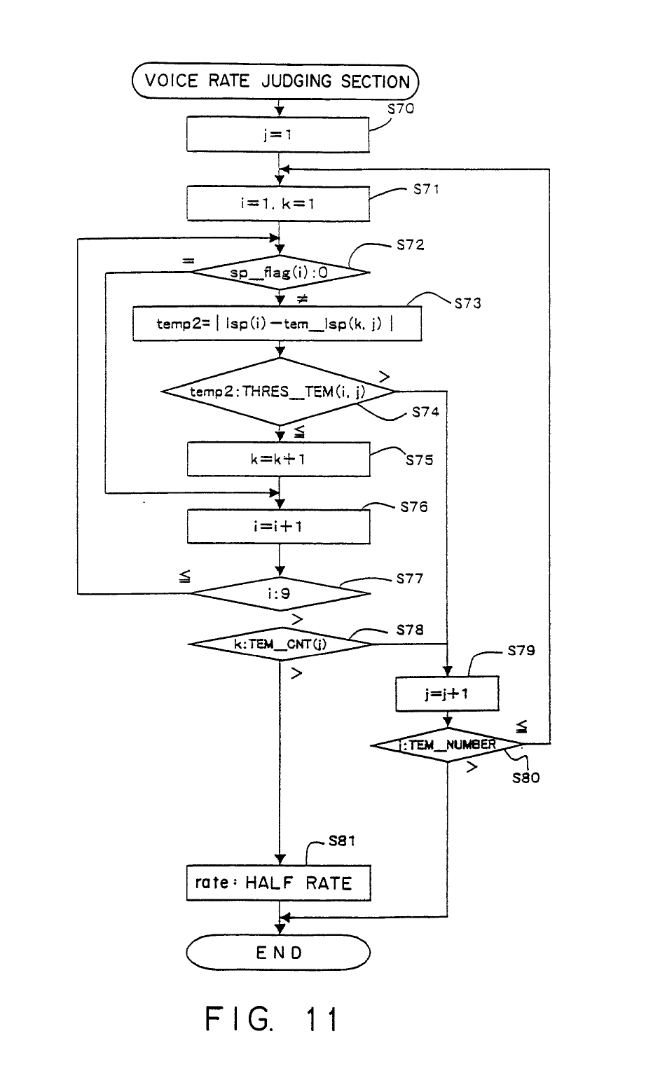

FIG. 11 is a flowchart showing the third preferred embodiment of the process of the voice rate judging section in the case where the template of an LSP coefficient is provided as the approximate pattern.

In this preferred embodiment, the voice rate judging section compares the i-th spectrum detection flag with a spectrum detection flag corresponding to the k-th peak of a specific template and judges whether the flags are matched.

First, in step S70, the section sets variable j for identifying a template to “1”. Then, in step S71, the section initializes both variable i for identifying the detected LSP coefficient lsp (i) and variable k for identifying LSP coefficient tem_lsp (k, j) included one template to “1”.

In step S72, the section judges whether spectrum detection flag sp_flag (i) is set to “0”. If the flag is not set to “0”, the flow proceeds to step S73. If the flag is set to “0”, the flow proceeds to step S76. In step S76, the section prepares for the process of a subsequent LSP coefficient and the flow returns to step S72. If in step S72, spectrum detection flag sp_flag (i) is not set to “0”, the section judges that the peak of an LPC spectrum is located in the position specified by i. Then, in step S73, the section calculates the absolute value temp2 of the difference between the calculated i-th LSP coefficient lsp (i) and the k-th LSP coefficient of the j-th template tem_lsp (k, j). If in step S74, temp2 is more than threshold value THRES_TEM (k, j), the section judges that there was no matching, and the flow proceeds to step S79. Then, in step S79, the section processes a subsequent template. If in step S80, it is judged that all the templates are processed, the section judges that the input voice signal is not a vowel and terminates the process.

If in step S74, it is judged that temp2 is equal to threshold value THRES_TEM (k, j) or less, the section judges that there was matching. Then, in step S75 the section increments k by one, in step S76, the section increments i by one and in step S77, the section judges whether all the spectrum detection flags are processed. If it is judged that all the spectrum detection flags are processed, in step S78, the section judges whether k is larger than the number of LSP coefficients included in the j-th template. If k is equal to TEM_CNT (j) or less, it means that step S75 is skipped (the number of the peaks in the LPC spectrum is not matched). Therefore, there is not a complete matching. Then, in steps S79 and S80, the section selects another template and the flow returns to step S71. If in step S78, k is more than TER_CNT (j), the section judges that a complete matching is obtained (the number of the peaks in the LPC spectrum has matched), and thus the input voice signal is a vowel. Then, in step S81, the section modifies the rate information “rate” to half the rate and terminates the process.

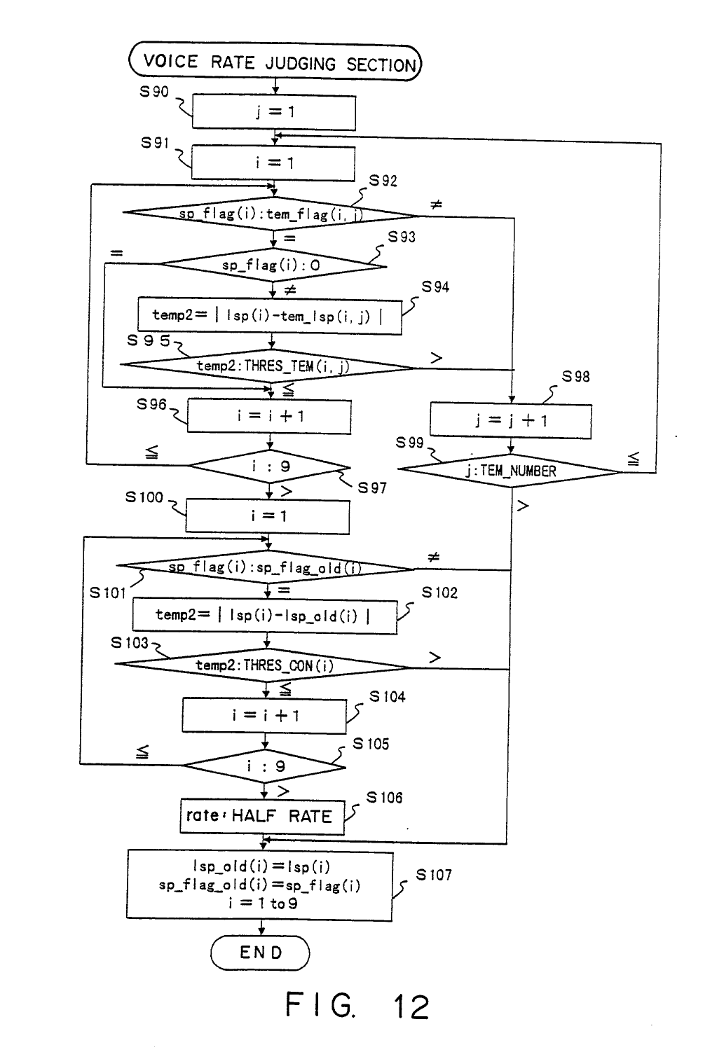

FIG. 12 is a flowchart showing the fourth preferred embodiment of the process of the voice rate judging section, the accuracy of which is improved by performing both the processes shown in FIGS. 9 and 10 together.

An approximate pattern detecting section is provided with a vowel model template and compares sp_flag ( ) from an LSP interval detecting section with the tem_flag ( ) of the model template. If the flags are matched, the section compares lsp ( ) obtained when sp_flag ( )=“1” with the tem_lsp ( ) of the template. By performing the same process as the processes shown in FIG. 9 only when the flags are matched, less degraded voice rate control can be implemented.

The upper and lower parts of the flowchart shown in FIG. 12 are the flowcharts shown in FIGS. 10 and 9, respectively. Therefore, only the outline is described here.

In steps S90 and S91, the section initializes variables and in step S92, the section checks whether the spectrum detection flag of the template and the spectrum detection flag obtained from the input signal are matched. If the flags are not matched, in steps S98 and S99, the section performs the same check using another template. If the flags are not matched in the case of any template, the section performs the process in step S107 and terminates the entire process. In step S93, the section judges whether the spectrum detection flag is set to “1”. If the flag is not set to “1”, the flow proceeds to the process of another spectrum detection flag. If the flag is set to “1”, the section checks the difference between the LSP coefficient value of the template and the LSP value obtained from the input signal. If the difference is equal to a threshold value or less, the section judges that the flags are matched and the flow proceeds to step S100.

In step S100, the section initializes a variable, and in step S101, the section checks whether a spectrum detection flag obtained from the immediately previous frame and a spectrum detection flag obtained from the current frame are matched. If the flags are not matched, the section performs the process in step S107 and terminates the entire process. If in step S101, the spectrum detection flags are matched, the section judges whether the difference between the LSP coefficient value of the immediately previous frame and the LSP coefficient value of the current frame is equal to the threshold value or less (steps S102 and S103). If the difference is larger than the threshold value, the section performs the process in step S107 and terminates the entire process. If the difference is equal to the threshold value or less, the section performs the process for all the spectrum detection flags. If each of the differences between the LSP coefficient value of the immediately previous frame and the LSP coefficient value of the current frame of all the spectrum detection flags is equal to the threshold value or less, the section judges that the voice signal of the current frame is a vowel and sets the rate information “rate” to half the rate. Then, the section performs the process in step S107 and terminates the entire process.

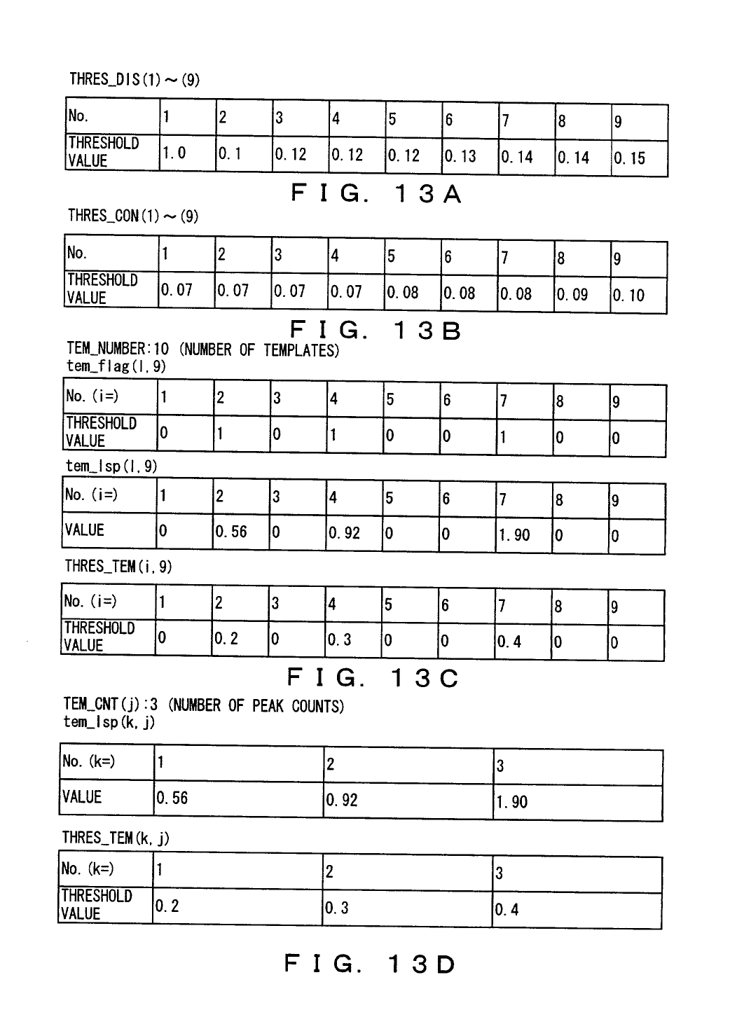

FIG. 13 shows the threshold values and templates used in the process flows shown in FIGS. 8 through 12.

FIG. 13A shows the threshold values used in the flowchart shown in FIG. 8. There are threshold values THRES_DIS (1) through (9). As shown in FIG. 13A, each threshold value is independently provided based on the position of each LSP coefficient. The higher the position of an LSP coefficient (the larger an LSP coefficient value on the frequency axis), the larger the threshold value. The first column of the table shown in FIG. 13A corresponds to threshold value THRES_DIS (1), and the subsequent columns correspond to THRES_DIS (2) through (9), respectively.

FIG. 13B shows the threshold values used in the flowchart shown in FIG. 9. As in FIG. 13A, there are threshold values THRES_CON (1) through (9), and each of columns corresponds to threshold values THRES_CON (1) through (9), respectively. Each of the threshold values shown in FIG. 13B is used to check the change with the passing of time of an LSP coefficient. In this case too, the larger an LSP coefficient value on the frequency axis, the larger the threshold value.

FIG. 13C shows examples of the templates used in the process flow shown in FIG. 10. TEM_NUMBER represents the number of templates, and in this case, there are ten templates. The tem_flag (i, 9) shown in FIG. 13C is a table corresponding to the spectrum detection flag of the ninth template. i takes each values of 1 through 9, and each column corresponds to each value of i. According to this table, it is found that the peaks of an LPC spectrum are located at i=2, 4 and 7. tem_lsp (i, 9) is a table for storing the LSP coefficient values in positions with the peak of an LPC spectrum. According to this table, each of the second, fourth and seventh LSP coefficient values are registered. However, this table can also register all the LSP coefficient values. However, since only positions, where the spectrum detection flag is set to “1”, are used, it is efficient to register only the LSP coefficient values in positions each with the peak of an LPC spectrum, as shown in FIG. 13C. THRES_TEM (i, 9) is a table used to register values used to judge whether the difference between the LSP coefficient value obtained from the input signal and the LSP coefficient value of a template is within an allowable range in the ninth template. In this case too, a threshold value is only registered in positions where the spectrum detection flag tem_flag (i, 9) of a template is set to “1”. In this case too, each column of the table corresponds to each value of i. Three of tem_flag (i, 9), tem_lsp (i, 9) and THRES_TEM (i, 9) constitute one template.

FIG. 13D shows examples of the templates used in the process flow shown in FIG. 11. TEM_CNT (j) represents the number of the peaks of an LPC spectrum in the j-th template. In this example, there are three peaks. In tem_lsp (k, j), LSP coefficient values corresponding to the first through third peaks included in the j-th template are registered. k is a number for identifying a plurality of peaks. THRES_TEM (k, j) is a threshold value used to judge whether the LSP coefficient value of the k-th peak of the j-th template is satisfactorily matched with the actually measured LSP coefficient value, and a threshold value is set for each peak. TEM_CNT (j), tem_lsp (k, 1) and THRES_TEM (k, j) constitute one template.

Since the position of a peak and the like slightly varies depending on a person that sounds a voice signal, both the template and threshold value in the preferred embodiments must be set to appropriate values.

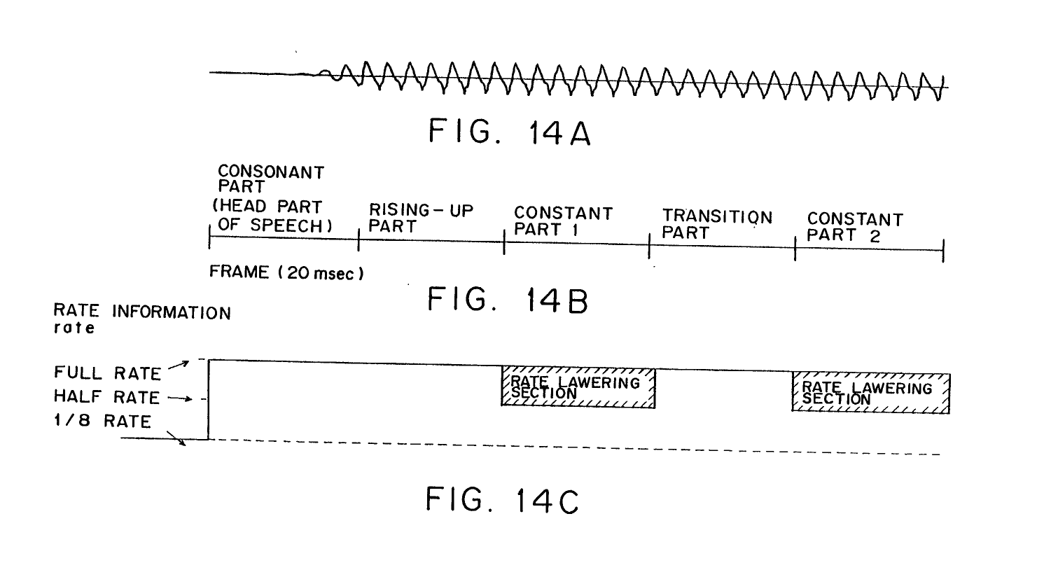

FIG. 14 shows both a voice waveform model and the operation example of the preferred embodiment of the present invention.

AT the head of a voice part, the rate determining section judges that the voice signal is voice. In a subsequent frame, vowel spectrum components continue. In this case, since the power related to a fixed codebook is low, there is no influence in voice quality even if the number of bits of the fixed codebook is reduced. Therefore, rate information is modified from the full rate to half the rate.

In the example shown in FIG. 14, since in another subsequent frame, the waveform (spectrum component) starts changing, the rate information is set to the full rate. In this way, the average encoding bit rate can be lowered without the degradation of voice quality, by modifying the rate information from the full rate to half the rate in a constant part where vowel spectra continue. Since a vowel voice signal lasts for several tens of milliseconds, in a vowel voice signal, the average encoding bit rate can be lowered without the degradation of voice quality, by modifying approximately 30% to 50% of the vowel voice signal from the full rate to half the rate.

In FIG. 14, in a voiceless state before a consonant part begins, the rate information is set to ⅛ the rate. Then, a head part of speech begins with a consonant. Therefore, the bit rate is set to the full rate there and the voice information of a consonant is encoded. A rising-up part follows the head part of speech. In the rising-up part, voice strength gradually increases and the rate information remains at half the rate. Then, a constant part 1 follows the rising-up part. In the example shown in FIG. 14, vowel “e” is constantly sounded. Therefore, the processes of the preferred embodiment are performed and the number of the encoding bits of the fixed codebook is reduced. Simultaneously, the rate information is set to half the rate. Then, in a transition part, since a voice signal mixed with consonant “r” is sounded, the rate information is restored to the full rate. In a constant part 2, since vowel “e” is constantly sounded, the number of the encoding bits of the fixed codebook is reduced and the rate information is set to half the rate.

Although in the description of the preferred embodiment given above, the bit rate of a voice encoded signal seems to be one of the full rate, half the rate and ⅛ the rate, the bit rate is not necessarily limited to the rates, and any rate, such as ⅔ the rate, ⅓ the rate and the like can also be set, if requested.

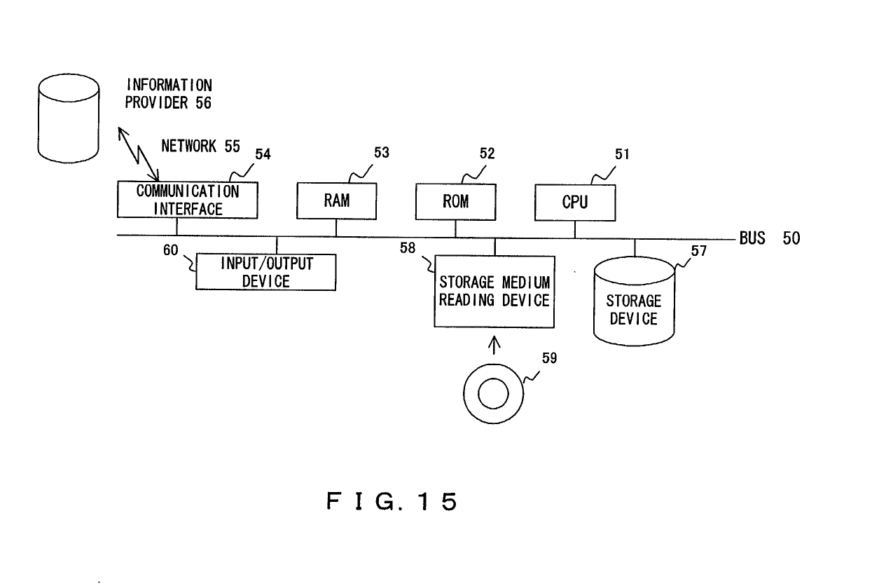

FIG. 15 shows the hardware configuration of the device in the case where the preferred embodiment of the present invention is implemented by software.

Although the preferred embodiments of the present invention are described assuming that the preferred embodiments are implemented by hardware, the preferred embodiments can also be implemented by software. In particular, if an Internet telephone, Internet conference system or the like is implemented, the preferred embodiment of the present invention can be implemented by installing software for implementing the process of the preferred embodiment of the present invention in a general-purpose computer.

In such a case, the device in which the relevant software is installed comprises a CPU 51 performing an operation process, and performs the process while transmitting/receiving data to/from other ROM 52, RAM 53 and the like through a bus 50. For example, the relevant software can be stored in a storage device 57, such as a hard disk and the like, can be stored in the RAM 53 and can be executed by the CPU 51. Alternatively, the relevant software can be installed in the ROM 52 when being manufactured at a factory, and the CPU 51 can read the software from the ROM 52 and execute the software. Alternatively, the relevant software can be stored and distributed in a portable storage medium 59. For the portable storage medium 59, for example, a floppy disk, a CD-ROM, a DVD and the like, can be used. In such a case, a user purchases the relevant software stored in such a portable storage medium 59 and uses the software by installing it in the storage device 57 using a storage medium reading device 58. Alternatively, a part of the relevant software can be directly read into the RAM 53, and the CPU 51 can execute the software while reading necessary programs from the portable storage medium, if requested.

In this case, instructions, reproduced voice and the like from a user are inputted/outputted through an input/output device 60, such as a keyboard, a mouse, a speaker and the like.

Alternatively, the relevant software can be downloaded from an information provider 56 using a communications interface 54 by connecting the computer to a network 55, such as the Internet and the like. In this case, the relevant downloaded software is stored in the portable storage medium 59 or storage device 57, and the CPU 51 reads/executes the software, if requested. Alternatively, if the network 55 is a LAN and the like, and if the information provider 56 is the server of the network (LAN), the software can be executed in the network environment without downloading the software.

In this way, thanks to the development of the Internet and the like, the software (program) for implementing the preferred embodiment can be distributed and executed in a variety of forms and these forms should be appropriately protected.

According to the present invention, the average encoding bit rate can be lowered without the degradation of voice quality by lowering an encoding bit rate when a voice part is sounded if the voice signal is a vowel.

What is claimed is:

1. A device for a variable-rate encoding system, comprising:
a judging unit judging whether a voice signal is a vowel when a voice part of a voice signal is sounded; and
a rate setting unit setting a voice encoding bit rate to a bit rate lower than the bit rate usually used when the voice part is sounded if the voice signal is a vowel.

2. The device according to claim 1, further comprising:
an LSP coefficient calculating unit calculating an LSP coefficient obtained from the voice signal; and
an LSP interval judging unit judging whether an interval between the LSP coefficients is equal to or less than a prescribed threshold value.

3. The device according to claim 2, wherein if one or more obtained intervals between adjacent LSP coefficients does not move and exists within a prescribed range for a specific time period, the LSP interval judging unit judges that the voice signal is a vowel.

4. The device according to claim 2, further comprising:
a template judging unit provided with a plurality of templates for registering LSP coefficients of a vowel, judging whether the LSP coefficient obtained from the voice signal is approximately equal to the LSP coefficient registered in the template, wherein if the template judging unit judges that the LSP coefficient obtained from the voice signal is approximately equal to the LSP coefficient registered in the template, the template judging unit lowers an encoding bit rate of the voice signal.

5. A rate control method for a variable-rate voice encoding system, comprising:
(a) judging whether a voice signal is a vowel when a voice part of the voice signal is sounded; and
(b) setting a voice encoding bit rate to a bit rate lower than the bit rate usually used when a voice part is sounded.

6. The method according to claim 5, further comprising:
(c) calculating an LSP coefficient obtained from the voice signal; and
(d) judging whether an interval between the LSP coefficients is equal to or less than a prescribed threshold value.

7. The method according to claim 6, wherein if one or more intervals between adjacent LSP coefficients obtained in step (d) do not move and exist within a prescribed range for a specific time period, it is judged that the voice signal is a vowel.

8. The method according to claim 6, further comprising:
(e) storing a plurality of templates for registering LSP coefficients of a vowel and judging whether the LSP coefficient obtained from the voice signal is approximately equal to the LSP coefficient registered in the template,
wherein if it is judged that the LSP coefficient obtained from the voice signal in step (e) is approximately equal to the LSP coefficient of the template, an encoding bit rate of the voice signal is lowered.

9. A computer-readable storage medium which records a program for enabling a computer to implement a rate control method for a variable-rate voice encoding system, the process comprising:
(a) judging whether a voice signal is a vowel when a voice part of the voice signal is sounded; and
(b) setting a voice encoding bit rate to a bit rate lower than the bit rate usually used when the voice part is sounded.

10. The storage medium according to claim 9, the process further comprising:
(c) calculating an LSP coefficient obtained from the voice signal; and
(d) judging whether an interval between the LSP coefficients is equal to or less than a prescribed threshold value.

11. The storage medium according to claim 10, wherein if one or more intervals between adjacent LSP coefficients obtained in step (d) do not move and exist within a prescribed range for a specific time period, it is judged that the voice signal is a vowel.

12. The storage medium according to claim 10, further comprising:
(e) storing a plurality of templates for registering LSP coefficients of a vowel and judging whether the LSP coefficient obtained from the voice signal is approximately equal to the LSP coefficient registered in the template,
wherein if it is judged that the LSP coefficient obtained from the voice signal in step (e) is approximately equal to the LSP coefficient of the template, an encoding bit rate of the voice signal is lowered.
